(19) United States
(12) Patent Application Publication
(10) Pub. No.: US 2007/0168866 A1
(43) Pub. Date: Jul. 19, 2007

(54) Method and system for constructing composite video from multiple video elements

(75) Inventors: Rajendra Kumar Khare, Bangalore (IN); Brajabandhu Mishra, Orissa (IN); Sandeep Kumar Relan, Bangalore (IN)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 11/392,903

(22) Filed: Mar. 30, 2006

Related U.S. Application Data
(60) Provisional application No. 60/758,530, filed on Jan. 13, 2006.

(51) Int. Cl. H04N 7/16; G06F 13/00; H04N 5/445; G06F 3/00; H04N 7/173

(52) U.S. Cl. 715/723; 725/135; 725/37; 725/131; 715/719

(57) ABSTRACT

A set top box circuitry receives television channels, receives a viewer input, constructs a composite video from the television channels using the viewer input and forwards the composite video for display. The viewer input identifies a selection of at least two of the television channels and another selection of portions or all of the at least two of the television channels. The viewer input carries definitions of the selected portions that are typically, dimensions of the selected portions, shapes of the selected portions and locations of the selected portions when revealed on a display. The set top box circuitry constructs the composite video by combining the selected portions using the definitions. The set top box circuitry maintains a usage record of the television channels that are not free to use and forwards the usage record to a charging system that uses the usage record to generate an invoice.

### BACKGROUND OF THE INVENTION

1. Field of the Invention

The present application makes relates to a set top box circuitry for video processing, and more particularly for customizing video based on video received from a plurality of sources, e.g., broadcast television, and viewer input.

2. Description of the Related Art

Television channel broadcasters provide hundreds of television channels to viewers. Of the hundreds, a viewer can subscribe to all or select few ones of the channels. Often, the viewer desires to watch several channels at once. Some television sets with PIP (Picture in Picture) functionality provide a second channel tuner through which a rectangular window can be opened to display a second channel as an overlay to the main screen display of a first channel. However, the window often blocks part of the view of the first channel display. This is especially problematic when the window extends into the center of the screen where most of the action from the underlying full screen channel takes place. Attempts to minimize the window so that it does not stray into the center of the screen often results in a windowed channel that is too small to perceive underlying details or adequately understand.

Moreover, viewers desiring to simultaneously watch two or more channels often are only interested in a portion of one or both channels. When the remainder, i.e., the portion in which the viewer is not interested, causes overlap, the viewer typically considers the PIP functionality entirely unacceptable. If they do not use PIP because of the unacceptable overlap problems, viewers are forced to quickly switch back and forth between channels to find out what is being telecast using typical remote control interaction. When performing the switching, viewers will miss what has been telecast on the other channel. These problems are compounded for each additional channel in which the viewer has interest.

Video editing systems are available in the market that combine two or more video sources in a variety of ways into a single video feed. These systems can switch between sources with simple cuts or create transitions such as dissolves, wipes, flips and zooming effects. Some of such systems can take video feeds from multiple cameras and make transitions between the video feeds, where effects such as dissolves, wipes can be used to smooth the transitions. Some can freeze a frame while playing a video feed and after a time can perform a transition to a new video feed. It can hold the frozen frame through the transition. Such video editing systems are typically used to compose a single video feed that is then delivered to millions of viewers knowing that at least a minority of the viewers will not find the feed acceptable.

Further limitations and disadvantages of conventional and traditional approaches will become apparent to one of ordinary skill in the art through comparison of such systems with the present invention.

### BRIEF DESCRIPTION OF THE DRAWINGS

For the present invention to be easily understood and readily practiced, various embodiments will now be described, for purposes of illustration and not limitation, in conjunction with the following figures:

FIG. 1 is a schematic block diagram illustrating a set top box (STB) circuitry according to an exemplary embodiment of the invention;

FIG. 2 is a schematic block diagram illustrating an embodiment of the set top box circuitry of FIG. 1 according to an exemplary embodiment of the invention;

FIG. 3 is a schematic block diagram illustrating an embodiment of the set top box circuitry of FIG. 2 according to an exemplary embodiment of the invention;

FIG. 4 is a schematic block diagram illustrating a video generation circuitry according to an exemplary embodiment of the invention;

FIG. 5 is a schematic block diagram illustrating an embodiment of the video generation circuitry of FIG according to an exemplary embodiment of the invention;

FIG. 6 is a schematic block diagram of an entertainment system that includes a video generation circuitry according to an exemplary embodiment of the invention;

FIG. 7 is a schematic block diagram illustrating a video generation circuitry that generates a composite video according to an exemplary embodiment of the invention; and

FIG. 8 is a flowchart illustrating a method of generating a composite video according to an exemplary embodiment of the invention.

### DETAILED DESCRIPTION

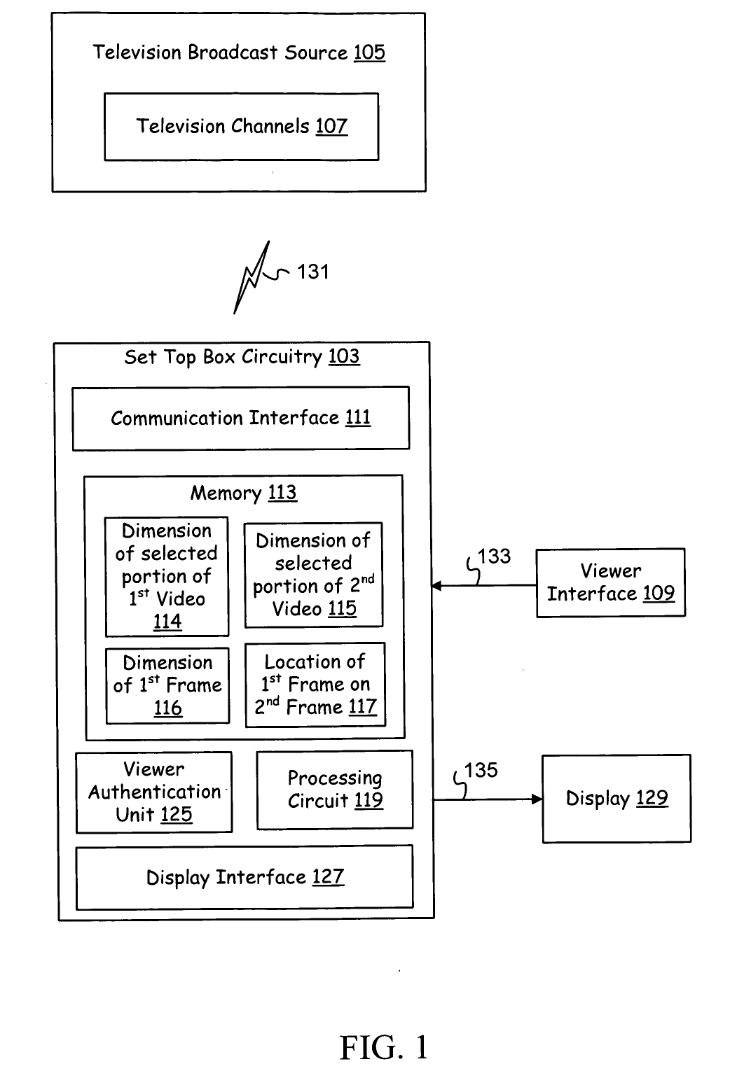

FIG. 1 is a schematic block diagram illustrating a set top box (STB) circuitry 103 that constructs a single video channel from both independent and extracted video elements, the extraction per viewer input and from a plurality of broadcast video channels in accordance with the present invention. For example, the STB circuitry 103 constructs a single composite video from portions or all of videos selected from two different television channels, the portions or all of videos being selected per viewer input. The viewer is provided with a selection means that makes it possible to select one or more video elements from one or more video sources, such as TV channels, to construct a composite video output that is presented as a new video source, such as a new TV channel, or as a composite video in one of the video sources. The set top box circuitry 103, a display 129 and a viewer interface 109 are typically located at a first premises, such as a viewer's home. The set top box circuitry 103 interacts with a television channel broadcasting source 105, located at a second premises, such as a cable TV head-end or broadcasting center. In one embodiment, the set top box circuitry 103 is part of a media player 103, that is capable of receiving multiple media elements and combining them, with other media elements. It is also capable of combining one media element with regions of interest derived from, or associated with, the other media elements.

The set top box circuitry 103 includes a communication interface 111 that it employs to communicate with the TV broadcast source 105 and the viewer interface 109. The set top box circuitry also includes a memory 113, a processing circuit 119, a viewer authentication unit 125 and a display interface 127. The set top box circuitry 103 is communicatively coupled to the television channel broadcasting source 105 over at least one of a wireless link 131 and a wired link. The wireless link 131 is one or more of a radio frequency link, a microwave link, a satellite link and a cellular phone link. The viewer interface 109 and the display 129 are communicatively coupled to the set top box circuitry 103 over communication links 133 and 135 respectively, that are each one or more of an infrared link, a direct link, a radio frequency link, a Bluetooth link, a cellular phone link and a 802.11 link.

The communication interface 111 is capable of receiving commands and control information from the viewer interface 109, which is a device such as a remote control that a viewer would employ to interact with the STB 103. The commands and control information from the viewer interface 109 identifies, for example, a first television channel and a second television channel that need to be combined in some way to provide a combined output that the viewer desires to view.

In one embodiment of the invention, prior to receiving the input from the viewer interface 109, the communication interface 111 receives a channel menu from the television channel broadcasting source 105 that it can display on the display 129 if the viewer wishes to browse through it. The channel menu identifies a plurality of television channels 107 available via the television channel broadcasting source 105. It also provides metadata information for the channels including regions of interest or portions of the channels that a user can select, for incorporation into other channels. The communication interface 111 delivers the channel menu to a display 129. The viewer interacts with the viewer interface 109 while viewing the display 129 visually while browsing the channel menu and making selections. In another embodiment of the invention, the set top box circuitry 103 stores the channel menu received from the television channel broadcasting source 105 in the memory 113.

The TV broadcast source 105 provides multiple TV channels to the STB circuitry 103, and a channel menu if necessary. The communication interface 111 receives these channels. For example, the communication interface 111 provides a first television channel and a second television channel from the television channel broadcasting source 105 so that the STB circuitry 103 could display them individually, or in some combined form, on the display unit 129. The viewer can provide information on portions of the first and second television channels that the viewer wishes to view in one single combined channel on the display unit 129. The viewer interface 109 provides the means to not only specify one or more channels from which the viewer wishes to select portions of video data, but also means to identify specific portions from the selected channels. The viewer interface 109 also makes it possible to specify the channel number or frequency band in which the combined video stream needs to be provided for display on the display unit 129.

In another embodiment of the invention, the portions of any TV channel or video source that a user can select, for incorporation into other TV channels or video sources, is provided as a video layer. Thus, only specific video layers that are transmitted as part of a TV channel by the TV broadcast source 105, or broadcast as part of a video data from a video source, such as from a video server on the Internet or a video stream from a DVD player, can be selected by a viewer. Combinations of such regions of interest that are presented and manipulated as video layers may be created by a user, the STB circuitry 103 facilitating the creation of such combinations and the subsequent display on a display unit 129, such as a TV.

A region of interest (ROI) is the selectable portion of a video stream or video data provided by a video source, local or remote. The concept of the “portion of a video” is a more generic concept than a “region of interest”. The term “media element” is used as a generic term that encompasses various sources of video data, such as video streams from an Internet media server, video data provided by a DVD player, a TV channel, etc. The region of interest can be detected in a media element, each media element having an associated metadata. Metadata may be one or more of media element characteristics that include but are not limited to, frame rate for example, and may further include ROI information. The media element affects the overall shape of a display region, etc. For example, the media element may be in a shape of a circle, or it could be heart shaped. The metadata associated with a media element is used to manage the instruction, placement, the sizing and other effects while displaying the media element. According to another embodiment of the invention, the media element may be configured to be displayed or turned on/off intermittently.

As per the availability of regions of interest (ROI) in any media element, the metadata identifying ROI may or may not accompany the media element. If the ROI is not provided by a broadcaster, such as a TV channel broadcaster, then it may be determined locally, such as by a STB circuitry 103, or by a display unit 129. If the ROI are identified remotely and provided along with the media elements, they can be selectively manipulated by a user using an input device, such as the viewer interface 109.

The communication interface 111 receives user selections, such as a channel number identifying a one or more TV channels, or portions of video (or even ROIs) in one or more TV channels, such user selections presented via the viewer interface 109. For example, a viewer may identify a portion of the first video data from a first TV channel and a portion or all of the second video data from a second TV channel as part of the viewer's selections. These portions of video (presented as ROIs, for example) may be presented by the associated video data, such as metadata, as individual selectable regions of interest. The viewer may also identify at least the size of a display frame 116 for the ROIs. Multiple display frames may be specified, and multiple locations for those display frames may be specified by the viewer. Such user identified channel information for the output includes but is not limited to, frame size information 116, location for the frames 117, etc. are stored in the memory 113 of the STB circuitry 103. Similarly, the details of the portions of the video sources, such as the TV channels from the TV broadcast source 105 from which the ROIs are retrieved, are stored in the dimension storage 114, 115. For example, the dimensions of selected portion of a first video channel or video source may be stored in the dimension storage 114 while the dimensions of selected portion (another ROI) of a second video channel or video source may be stored in the second dimension storage 115. In general, multiple such dimension storage 114, 115 are provided in the memory 113 by the STB circuitry 105

The processing circuit 119 manages the display of a portion of the video from a selected source/stream in an associated frame, a portion of another video from another source/stream in its own associated frame, and so on. The processing circuit 119 also displays at least a portion of a given video in an associated frame. The size of the associated frame is such that it covers the display 129 fully, or partially, as specified by a viewer. The processing circuit 119 overlays some of the frames, as necessary. For example, the first frame may be overlaid on the second frame and hence a single composite video is generated. The specification of where (the locations or coordinates) one frame overlays another is computed by the processing circuit 119 based on user specified overlay. The second input also identifies location of the first frame on the second frame 117. The processing circuit 119 forwards the composite video to the display 129 for display.

The viewer interface 109 may provide, a resolution information, relative or absolute brightness information of the portion of any video, or for an ROI from the video, that is selected by the viewer, etc. This is in addition to the identification of specific portions from the selected channels, a channel number or frequency band in which the combined video stream needs to be provided for display on the display unit 129, etc. In an embodiment, the set top box circuitry 103 stores user input received, such as the first input for a first channel or first video source and the second input for a second channel (or a second video source), in the memory 113.

The viewer authentication unit 125 of the set top circuitry 103 allows only an authenticated viewer to operate the set top box circuitry 103. Viewer authentication may be based on means that include but are not limited to, a password, a smartcard, a key, a digital certificate, GPS based authentication and a voice recognition, etc. or a combination of these authentication means.

Based on the availability of regions of interest (ROI) in any media element, a viewer can chose from those that are provided by the broadcaster of the media elements, such as a cable TV broadcast station. In general, the metadata identifying ROI may or may not accompany the media element. If the ROI is not provided by a video source, such as a cable TV broadcast station, then it may be determined locally by the STB circuitry 103. If the ROI are identified remotely and provided along with the media elements, they can be selectively manipulated by a user using an input device, such as the viewer interface 109, which in one embodiment, is a remote control. In general, the media elements, including associated ROI, may come from local and remote media sources. They arrive at the STB circuitry 103, or a media player, and the user can browse through list of ROI. The user interacts with STB circuitry 103, or the media player, to setup the combined video output for display. Such setup may be done on the fly. Such setup with the user specified combination of media elements and ROIs may be preconfigured with the correct or desired combination.

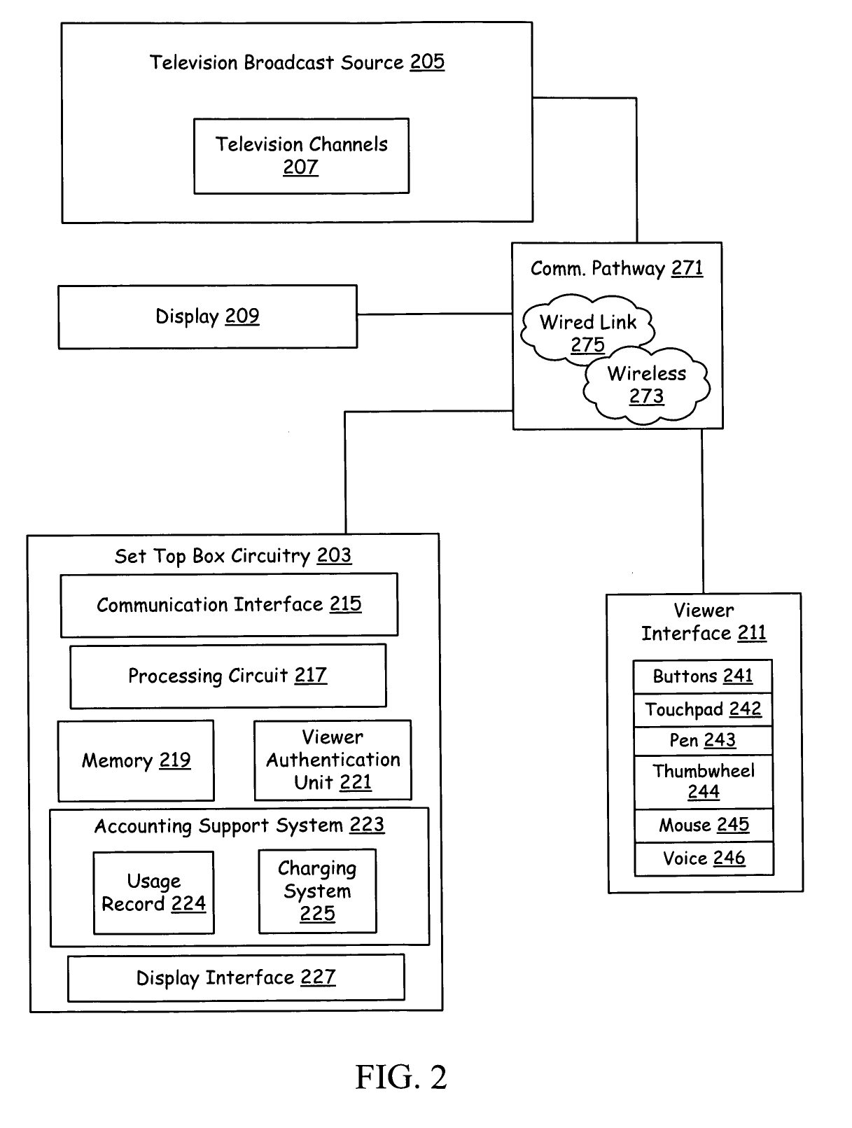

FIG. 2 is a schematic block diagram illustrating an embodiment of the set top box circuitry 203 of FIG. 1 further providing viewer charging/invoicing support for the composite video generation functionality. The set top box circuitry 203 receives two television channels at a time from television channel broadcasting source 205. It receives viewer input from viewer interface 211. The set top box circuitry 203 generates a single composite video output from the two television channels using the viewer input received from the viewer interface 211. The set top box circuitry has an accounting support system 223, such as a charging system that is capable of generating a usage record or a charge detail record. The accounting support system 223 keeps usage record 224 of the two television channels. Although FIG. 2 is described in terms of two TV channels for exemplary purposes, in practice this need not be limited to only two TV channels, and is expected to incorporate several TV channels as well as other video sources.

The accounting support system 223 includes a charging system 225. The charging system 225 generates an invoice, or a charging notification, using the usage record 224 for a viewer who operates the set top box circuitry 203. For example, if a first TV channel is a pay-per-view TV channel and portions from the first TV channel, such as two ROIs, are viewed along with a second TV channel displayed on the display unit, the charging system 225 creates a usage record 224 with the details necessary. Such usage records can be viewed by the user by browsing for it in the STB circuitry 203, or received as a notification that can be viewed on the display unit 209.

Some of the television channels received by the set top circuitry 203 may be free to use while other may not. The charging system 225 takes into account all these facts while generating a usage record or an invoice. In one embodiment the charging system 225 is a pre-paid card based. The charging system does not allow the set top box circuitry 203 to generate the composite video from the two television channels if the pre-paid card is invalid or the pre-paid card has zero balance. In another embodiment, the charging system 225 is post-paid based. The charging system 225 sends the usage record 224 to the television channel broadcasting source 205.

In one embodiment, the charging system 225 is also a billing system 225 that can take subscription information, subscription rates and other information into account to create the invoice or a bill that can viewed by a viewer, such as after a pay-per-view channel is viewed in combination (i.e. for example, when regions of interest from the pay-per-view channel is combined with a free channel and viewed superimposed on the free channel) with other free broadcast channels.

The viewer interface 211 includes buttons 241 that the viewer can use to enter preferences, select preferences and provide authentication information (if necessary), a touchpad 242 that can be used to make selections (such as from a list presented on the display unit 209), a pen 243 for using a touch sensitive screen on the viewer interface 211, a thumbwheel to scroll up and down lists and on information presented, a mouse 245 to navigate a screen and make selections, and a voice activated input 246 that makes it possible to provide voice input for making selections or searching for information.

Communication path 271 includes both wired link 275 and wireless links 273. For example, in the case of television broadcast TV source 205, communication with the STB circuitry 203 may be over a cable TV (wired) links, over satellite links (such as for satellite broadcasts of TV channels that are received over antennas at a user premises), over fiber optic links, etc. Similarly communications between the display unit 209 and the STB circuitry 203 may be over coaxial cable, over a LAN, over WiFi networks, etc. Finally, communications between the viewer interface 211, such as a remote control unit, and the STB circuitry 203 may be over infra-red links, Bluetooth links, WiFi links, Ultra-wideband links, etc.

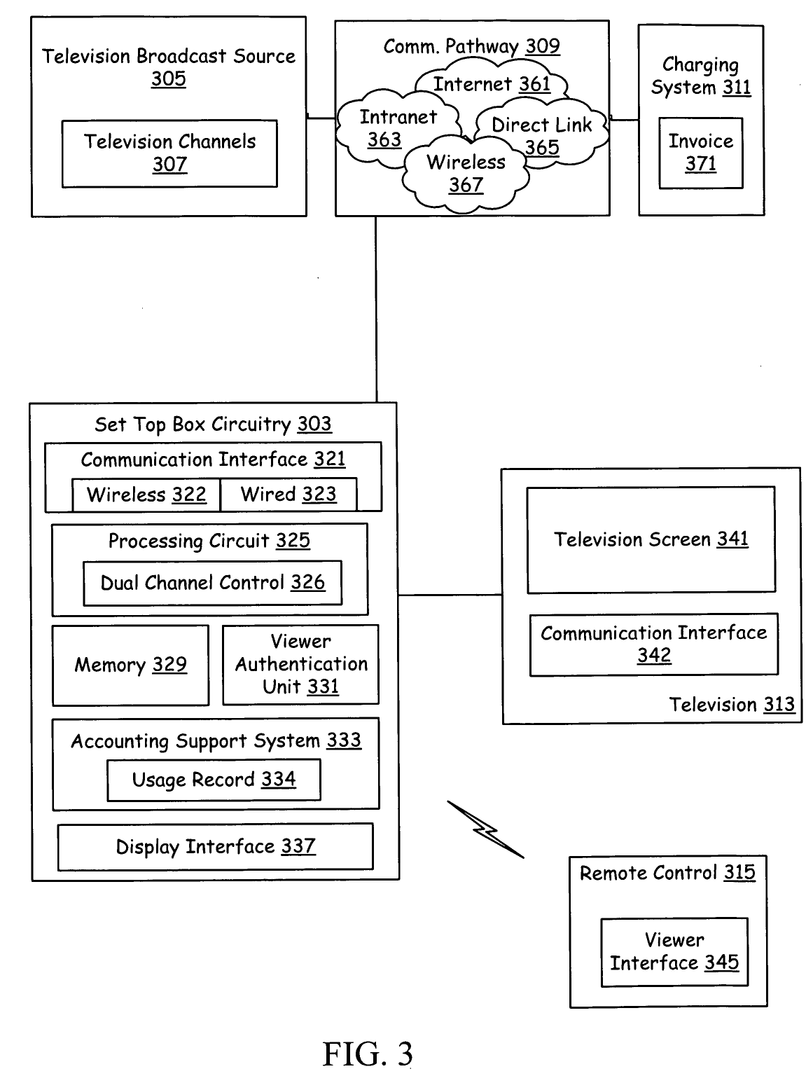

FIG. 3 is a schematic block diagram illustrating an embodiment of the set top box circuitry of FIG. 2 where the set top box circuitry 303, the television broadcast source 305 and a charging system 311 are located at three separate different remote premises with the display unit being a television 313 and the viewer interface is incorporated into a remote control 315 for the television 313. The set top box circuitry 303 receives at a time two television channels from the television broadcast source 305. Processing circuit 325 of the set top box circuitry 303 constructs a composite video from the two television channels and delivers it to the television 313 for display on television screen 341. The processing circuit 325 supports dual channel control.

The set top box circuitry 303 is located at a first premises, such as a user's house. The television broadcast source 305 is located at a second premises, such as a cable TV station, and the charging system 311 capable of creating invoices 371 being located at a third premises, such as a data center. An accounting support system 333 of the set top box circuitry 303 keeps usage record 334 of television channels received by the set top box circuitry 303. The set top box circuitry 303 is communicatively connected to the charging system 311 over at least one of an Internet 361, an Intranet 363, a direct link 365 and a wireless link 367.

Typically, the set top box circuitry 303 sends the usage record 334 to the charging system 311. The charging system 311 generates an invoice 371 using the usage record 334 for a viewer who operates the set top box circuitry 303, such as the viewer with a subscription for cable TV and for premier services. In one embodiment, the set top box circuitry 303 and the charging system 311 are not communicatively connected, and charging occurs in a batch mode periodically when the charging system is provided usage records in an offline mode. In another embodiment, the set top box circuitry 303 sends the usage record 334 to the television broadcast source 305 which forwards the usage record 334 to the charging system 311. The charging system 311 then optionally sends the invoice 371 to the television broadcast source 305, such as for user review and user approval.

The set top box circuitry 303 receives at least two television channels at a time from the television broadcast source 305. The two television channels are also received by the television 313 and displayed on the television screen 341. A viewer interacts with the television screen 341 using buttons on the TV 341 and with the set top box circuitry 303 through a viewer interface 345 of a remote control 315. Alternatively, the remote control 315 is used to interact with both the STB circuitry 303 as well as the TV 341. The processing circuit 325 of the set top box circuitry 303 constructs the composite video from the two television channels using a viewer input received remote control 315 (i.e. the from the viewer interface 345 that it embodies). The set top box circuitry 303 delivers the composite video to the television 313. The television 313 displays the composite video on the television screen 341. The set top box circuitry 303 is communicatively connected with the television 313 and the remote control 315 over one or more an infrared, an RF, a direct, and a Bluetooth link.

The viewer is able to select one or more ROIs from each of the media elements (i.e. TV channels) and have a generated combined video output delivered to the TV screen 341 for viewing. The user can browse the metadata of the media elements if they are presented by the TV broadcast source 305 or locally, by the STB circuitry 303 (having received it from a remote source, such as the TV broadcast source 305 earlier, perhaps periodically, for local storage and delivery to user). A dual channel control 326 in the STB circuitry 303 facilitates the selection of the two channels, the identification of metadata (including ROIs) from the channels and the retrieval of ROIs from them.

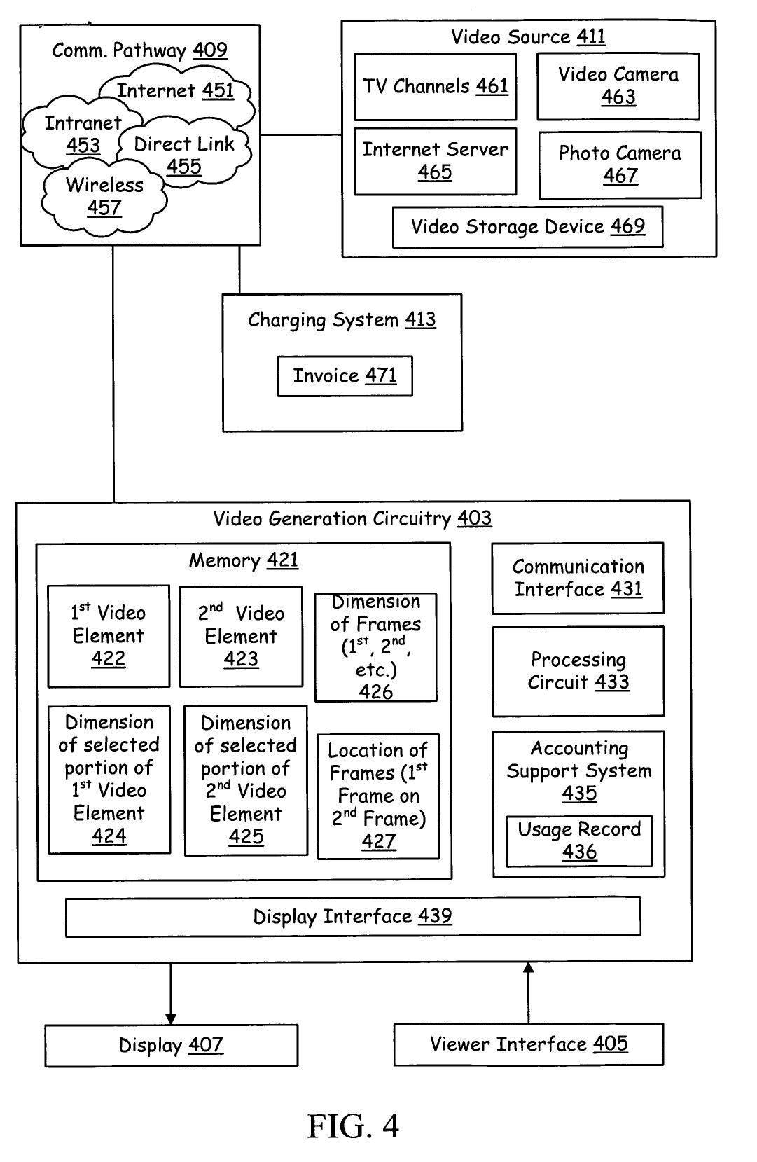

FIG. 4 is a schematic block diagram illustrating a video generation circuitry 403 that generates a composite video from one or more media elements to generate a composite video that can be broadcast to multiple remote viewing systems, such as televisions. For example, a combined video output from portions of a first video and portions or all of second video can be created, wherein both the first video and the second video are selected from a plurality of video elements, the selection facilitated by the use of a viewer interface 405 and a display unit 407 on which the viewer can browse through available options, make selections and review combined outputs. The videos that are combined by the video generation circuitry 403 are selected as per the viewer's input.

In one embodiment, the video generation circuitry 403 is communicatively coupled with a video sourcing system 411. The video generation circuitry 403 is located at a first premises, such as a broadcast TV station or a program generation studio. The video sourcing system 411 is located at a second premises, such as a library of video content, an Internet video server or an online repository of video programs. The video sourcing system 411 can also be a live broadcasting system that is capable of capturing live video (such as a broadcast from a sporting event). Thus, the video sourcing system 411 is one or more of, but not limited to, television channels 461, a video camera 463, an Internet server 465, a photo camera 467 and a video storage device 469. The combined output generated by the video generation circuitry 403 is stored for subsequent broadcast, with associated charging information available at the charging system 413. In another embodiment, the combined output generated by the video generation circuitry 403 is broadcast to several set-top-boxes of different viewers (the set-top-boxes being located at the individual viewer's premises and communicatively coupled to a TV).

The video generation circuitry 403 is communicatively coupled to the viewer interface 405 and the display unit 407. The video generation circuitry 403, the viewer interface 405 and the display 407 are co-located at the same premises, such as a studio of a broadcast TV network or a video generation company environment. The video generation circuitry 403 includes a memory 421, a communication interface 431, a processing circuit 433, an accounting support system 435 and a display interface 439. The communication interface 431 receives a video guide or a video catalog from the video sourcing system 411 and forwards it to the display 407. The video guide identifies a plurality of video elements available with the video sourcing system 411. The video guide may also include of a metadata information, such as ROIs, associated with the video data/media elements. Subsequently the communication interface 431 receives a viewer input from the viewer interface 405 when the viewer has made selections of media elements, ROIs that need to be deleted, combined or highlighted, etc.

In an embodiment of the invention, the viewer input identifies one or more video elements that are to be combined to generate a combined output, the video elements being identified thorough a video guide. For example, a first video element and a second video element may be identified by a viewer from the video guide. The communication interface 431 receives the first video element 422 and the second video element 423 from the video sourcing system 411 through one or more of a Internet 451, an Intranet 453, a direct 455 and a wireless link 457. The first video element 422 and the second video element 423 are at least one or more of a video part of a television channel, excerpts from a live video program, a video game, a stored video, and a picture. The memory 421 stores the first video element 422 and the second video element 423 for processing, mixing and display.

The processing circuit 433 is communicatively coupled to the communication interface 431. The communication interface 431 receives viewer input from the viewer interface 405. The memory 421 stores one or more viewer inputs. The viewer inputs that are stored (for subsequent retrieval and usage) identify portions of one or more media elements that need to be combined, perhaps on top of one of the media elements that serves as a background. For example, a first video element and at least a portion a second video element may need to be combined as per a viewer input (that may have been saved). The viewer input may also identify a display screen dimension by providing a first frame 426 specifications. The processing circuit 433 displays the portion of the first video element in the first frame as per the first frame 426 specifications. The processing circuit 433 displays the at least portion of the second video element in a second frame, the specifications for which may also have been provided by a viewer. The dimension of the second frame may be such that it covers the display 407 fully, in which case, the processing circuit 433 overlays the first frame on top of the second frame thereby generating a single composite video that can stored, viewed on the display unit 407 or transmitted to other remote televisions or display units. The viewer input thus includes, in this example, location 427 and dimensions of the first frame 426 on the second frame 425. The processing circuit 433 forwards the composite video to the display 409 for display, if necessary, to enable a user to view it during the generation process.

The viewer input from the viewer interface 405 includes a resolution, a brightness, a shape of the portion of the one or more video elements or subsets thereof (for example, a first video element and the portion or all of the second video element) and a shape of one or more frames needed to display the video elements (for example, the shape of a first frame that is used to display the first video element). The viewer selects these parameters or inputs them via the viewer interface 405.

Video elements received by the video generation circuitry 403 may or may not be free to use. For example, a picture or video stored in a camera or in a DVD is free to use, as well as some of broadcast channels transmitted by a television channel broadcaster. Few video elements are not free. A video game, a video excerpt (portions of a movie, a video news sequence, etc.), a movie available in Internet that is hosted by an Internet server 465, are typically not free to use. The accounting support system 435 of the video generation circuitry 403 maintains a usage record 436 for the pay videos used by the video generation circuitry 403 to generate the composite video. The communication interface 431 forwards the usage record 436 to a charging system 413 that generates an invoice 471 using the usage record 436. In one embodiment of the invention, the charging system 413 is communicatively coupled to the video generation circuitry 403. In another embodiment, the charging system 413 is communicatively coupled to the video generation circuitry 403 via the video sourcing system 411. The charging system 413 is located at the second premises that is different from the video generation premises where the video generation circuitry 403 is located.

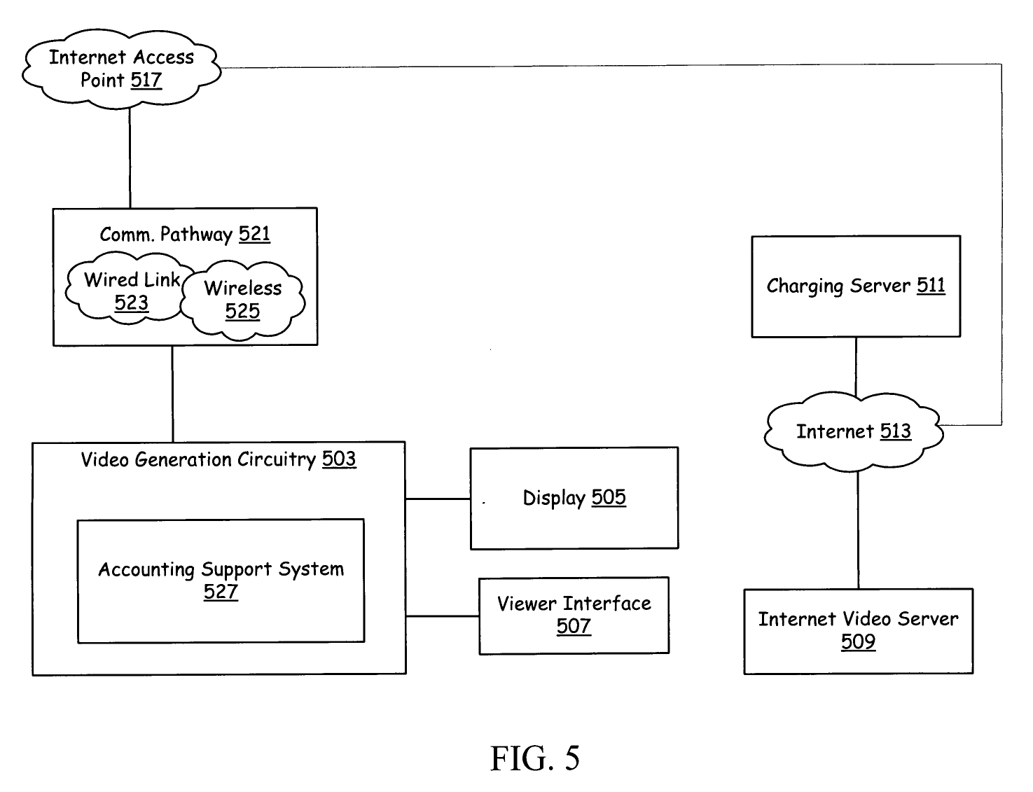

FIG. 5 is a schematic block diagram illustrating an embodiment of the video generation circuitry of FIG. 4 further supporting online charging and payment for the display of plurality of video elements by a viewer. The video generation circuitry 503 is communicatively coupled to an Internet video server 509 through an Internet access point 517. It is communicatively coupled to a charging server 511 via Internet 513 and is also communicatively coupled to a display 505 and a viewer interface 507. The video generation circuitry 503 includes an accounting support system 527. The video generation circuitry 503 is communicatively coupled to the Internet access point 517 over at least one or more of a wired link that is typically an Ethernet, a coaxial cable, a wireless link that is typically a 802.11, and a Bluetooth link.

The video generation circuitry 503 receives a viewer input from the viewer interface 507. The viewer input identifies one (or more) media element that is stored in the Internet video server 509. The media element may not be free to use. The accounting support system 527 of the video generation circuitry 503 interacts with the charging server 511 via Internet 513 for determining the cost of acquiring viewing and editing rights of the media element. In addition, a charging information for the combined output is computed or otherwise determined and stored at the charging server 511 (or at the video generation circuitry 503), or incorporated into a metadata of the combined output. When a viewing system, such as a STB or a TV that receives the combined output subsequently, receives the combined output, payment for the media rights (viewing or purchasing it) is done using a pre paid card or credit card by the viewer through the Internet 513, or automatically conducted by a transaction involving the STB or TV and the charging server 511. Payment through the Internet 513 may also involve a viewer initiated interactive session using the remote control (such as the viewer interface 507) and the charging server 511.

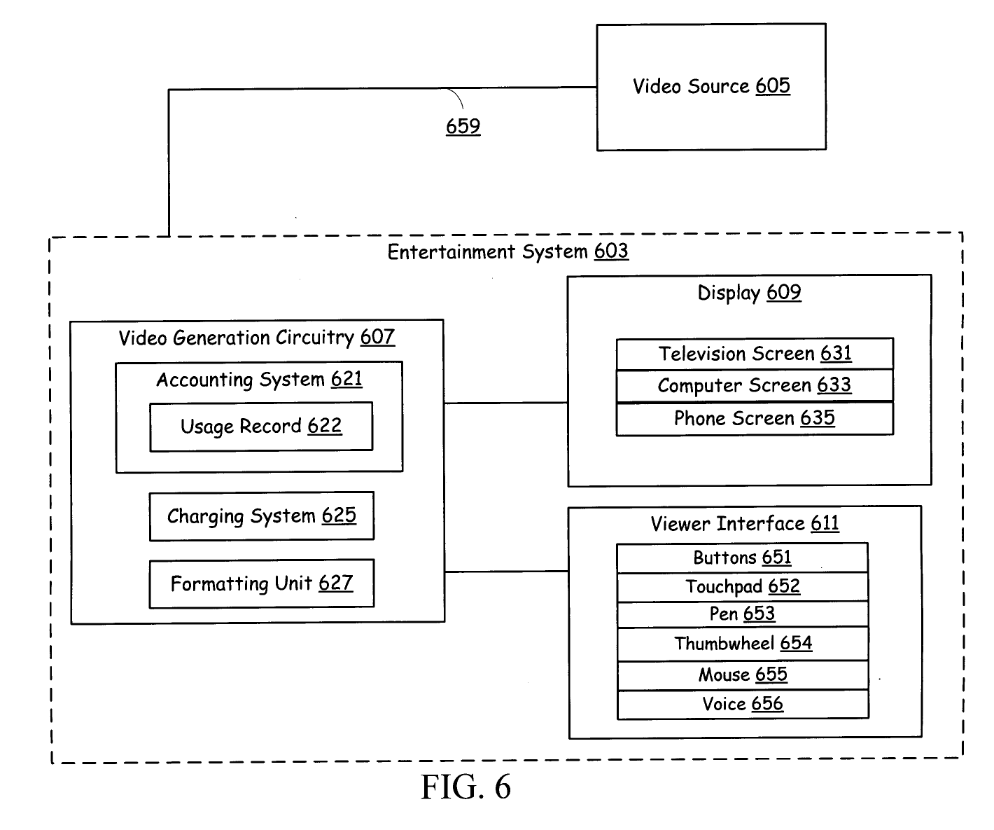

FIG. 6 is a schematic block diagram of an entertainment system 603 that includes a video generation circuitry capable of generating a combined video and multiple display systems such as a TV screen 631, a computer screen 633 and a multi-media capable phone screen 635, according to an exemplary embodiment of the invention. The entertainment system 603 is communicatively coupled to a video sourcing system 605 over a link 659, which is a wireless link or a wired link. The entertainment system 603 includes the video generation circuitry 607, a display 609 that is one of a TV screen 631, a computer screen 633 and a multi-media capable phone screen 635, and a viewer interface 611. The video generation circuitry 607 is provides a combined output, based on user preferences and selections, to the display 609, the viewer interface 611 being used for specification of such user preferences and selections. The entertainment system 603 is located at a first premises, such as a viewer's home, and the video sourcing system 605 is located at a second premises, such as at a cable TV broadcasting station or an Internet media center.

The display 609 is one or more of a television screen 631, a computer screen 633 and a phone screen 635. The viewer interface 613 includes at least one or more of buttons 651, a touchpad 652, a pen 653, a thumbwheel 654, a mouse 655 and a voice based 656. The video generation circuitry 607 includes a formatting unit 627 that is capable of converting the combined output to the needs of the display unit employed for viewing. Such converting may include of changing the dimensions of the frames, the resolution, the frame rate, etc. based on device capabilities, the network latency, the constraints of the device, etc.

A media element received by the entertainment system 603 from the video sourcing system 605 is combined with user selected regions of interest from other media elements that are statically or dynamically generated. The combined output is then forwarded to the formatting unit 627, to make it compatible with the display unit or device that renders it for viewing by the viewer. For example, the television screen 631 may support only a format that is prescribed for the television screen 631, for e.g., HDTV (High Definition Television) format. The computer screen 633 may support another format for e.g., VGA (Video Graphics Array) format. The phone screen 635 supports yet another format for e.g., QVGA (Quarter Video Graphics Array) format. The media element from the video sourcing system 605 may be in VGA format and the combined output media element generated by the video generating circuitry 607 may have to be displayed on the phone screen 635. The formatting unit 627 formats the combined output media element, as and when necessary and forwards it to the associated (or user specified) display 609.

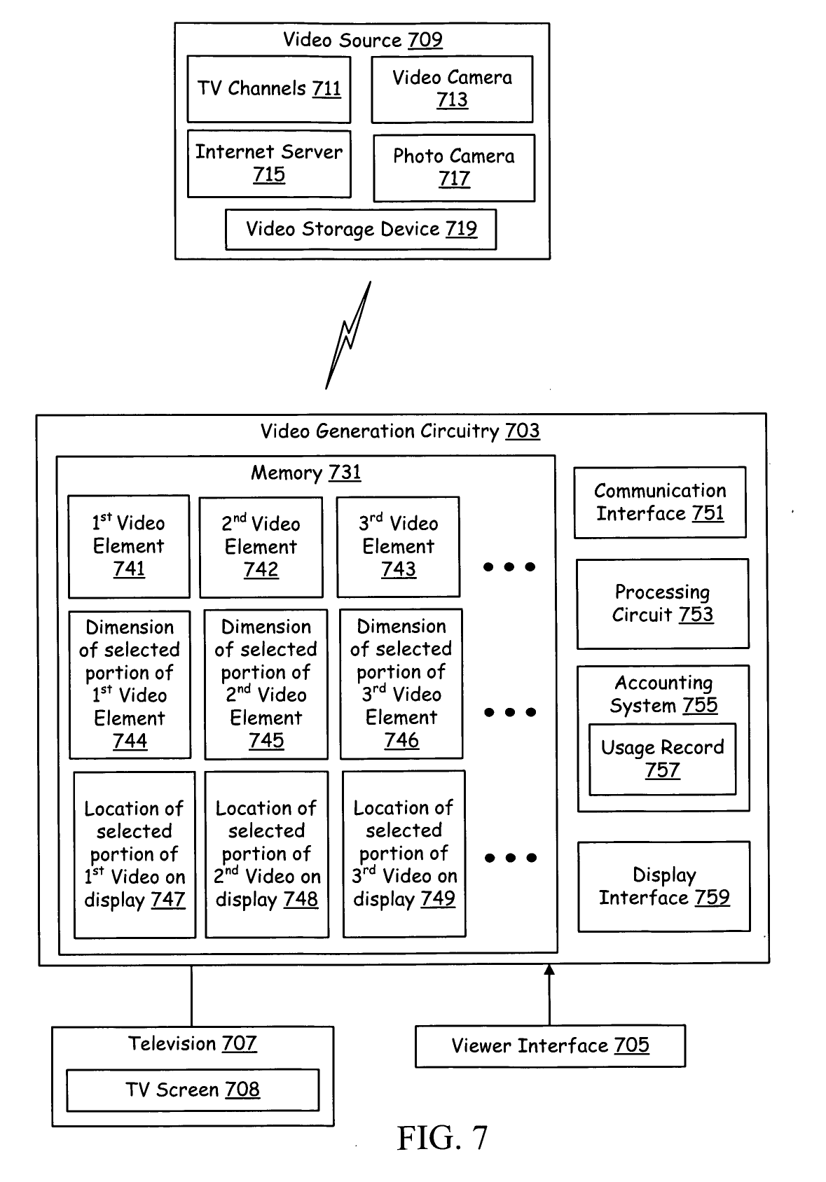

FIG. 7 is a schematic block diagram illustrating a video generation circuitry 703 that generates a composite video from portions selected from a plurality of media elements, the media elements may or may not have associated metadata and may or may not be accompanied by regions of interest, according to an exemplary embodiment of the invention. A viewer provides input using a viewer interface 705 that is communicatively coupled to the video generation circuitry 703. The viewer can choose between the various video sources 709, such as a TV channels system 711, an Internet media server 715, a video camera 713, and a photo camera 717. The various video sources provide media elements that are received and processed by the video generation circuitry 703. A remote video storage device 719, such as a personal video recorder (PVR) or a shared media repository, can also serve as a video source. The viewer interface 705 is, for example, a remote control of the television 707. The video generation circuitry 703, the viewer interface 705 and the television 707 are located at the same premises that is local to a viewer. The video generation circuitry 703 includes a memory 731, a communication interface 751, a processing circuit 753, an accounting support system 755 and a display interface 759.

The video generation circuitry 703 is communicatively coupled with the video sourcing system 709. The video generation circuitry 703 is located at a first premises, such as a viewer's home, and the video sourcing system 709 is located at a second premises that is different from the first premises. The video sourcing system 709 provides a plurality of video elements that a viewer can select for viewing. For example, the media elements may be a live broadcast on a TV channel, a prerecorded program on a TV channel, a video game, a stored video, or a digital picture.

The video generation circuitry 703 is communicatively coupled to the viewer interface 705 and a television 707. A viewer would select one or more media elements from the video source 709, using the viewer interface 705, which, in one embodiment, is a remote control unit capable of facilitating selection of channels and selection of regions of interest in the media elements.

The television 707 receives the first plurality of video elements from the video sourcing system 709 and can display them on television screen 708. A viewer interacts with television 707 using the viewer interface 705 or by using buttons, controls, dials, etc. provided by the television 707. When a viewer wishes to watch a combined output on the television 707, the combined output created by combining media elements, or by combining (mixing) regions of interest from one or more media elements onto another, the viewer employs the viewer interface 705 to browse through the catalog of media elements, or a online menu of media elements, selects those that interest him, in whole or in part (selecting regions of interest) and specifying the TV channel in which the combined output should be presented (or merged with). Subsequently the video generation circuitry 703 retrieves the media elements from the video source 709, extracts regions of interest if needed to merge them onto other regions of interest or other media elements as specified by the viewer, and generates the combined output for display on the TV system 707 or for local or remote storage.

In one embodiment of the invention, the viewer input provided through the viewer interface 705 identifies a plurality of portions selected from a first media element and a second plurality of media elements. The viewer input identifies the dimensions of the plurality of portions, such as dimensions 744, 745 and 746 selected for the second plurality of media elements. The processing circuit 753 is communicatively coupled with the communication interface 751 and the memory 731. The processing circuit 753 generates a composite video from the plurality of portions selected from the second plurality of media elements by a viewer. It delivers the composite video to the television 707. The television 707 displays the composite video on the television screen 708. The composite video, when displayed, reveals the plurality of selected portions on the television screen 708 simultaneously, as a combined output. The viewer input identifies the locations of the plurality of selected portions of the various media elements, such as locations 747, 748 and 749 on the television screen 708. The viewer input, in addition, specifies one or more of shapes, brightness, and resolution of the plurality of portions.

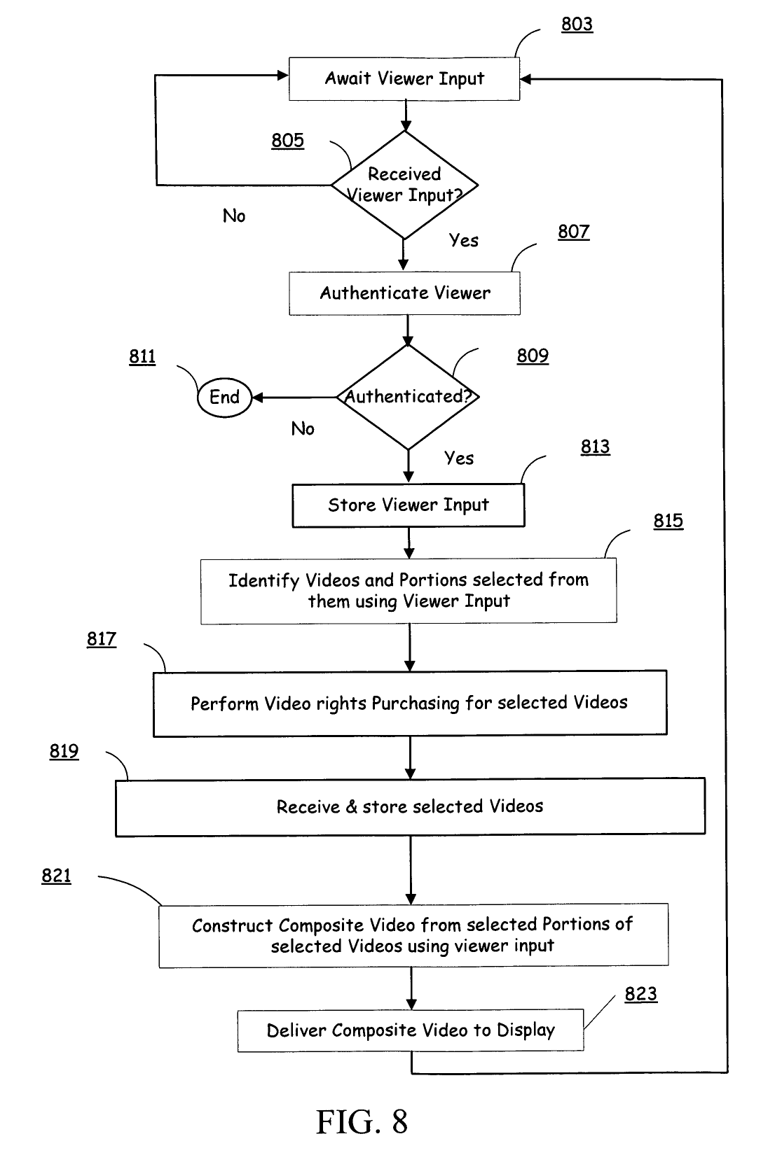

FIG. 8 is a flowchart illustrating a method of generating a composite video from a plurality of video elements by a video generation circuitry as per viewer input and through interaction with a video sourcing system, according to en exemplary embodiment of the invention. Processing starts at the block 801. Then at a next block 803, the video generation circuitry awaits viewer input. At the next block 807, after viewer input is received, the viewer is authenticated. On successful authentication at the block 807, at the next block 813, the video generation circuitry stores the viewer input.

At the next block 815, the video generation circuitry identifies media elements and regions of interest selected from the media elements (such as a video stream) using the viewer interface (such as a remote control). At the next block 817, video rights are purchased, as necessary, for the media elements identified by the viewer provided input. In one embodiment, a charging detail record is created and stored, or optionally communicated to a billing system, indicating the need to bill the viewer for the consumption of the media elements.

Then, at a next block 819, the video generation circuitry receives and processes/manipulates the media elements. It optionally stores them. At the next block 821, it constructs a single composite video from the regions of interest selected from the media elements using viewer specification information available in the viewer input 821. At the next block 823, the video generation circuitry delivers the composite video for display on a display unit, such as a television. Finally, the processing jumps back to the block 803 as the video generation circuitry is ready to receive another viewer input and generate another composite video.

As one of average skill in the art will appreciate, the term “communicatively coupled”, as may be used herein, includes wireless and wired, direct coupling and indirect coupling via another component, element, circuit, or module. As one of average skill in the art will also appreciate, inferred coupling (i.e., where one element is coupled to another element by inference) includes wireless and wired, direct and indirect coupling between two elements in the same manner as “communicatively coupled”.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

We claim:

1. A video processing circuitry located at a first premises that interacts with a video source located at a second premises, the video processing circuitry capable of interacting with a viewer interface and a display unit, the video processing circuitry comprising:
the video processing circuitry that is communicatively coupled to the viewer interface;
a processing circuitry capable of creating a combined video based on a viewer selection provided via the viewer interface by a viewer;
wherein the video processing circuitry receives a first media element and a second media element from the video source and each of the first media element and the second media element includes at least one region of interest; and
wherein the processing circuit generates a combined video by combining at least a portion of the first media element with a second media element based on the viewer selection received.

2. The video processing circuitry of claim 1, further comprising:
wherein the first media element further includes a first plurality of region of interest;
wherein the viewer selection includes at least one of the first plurality of region of interest that is selected by the viewer; and
wherein the processing circuit generates a combined video by combining the at least one of the first plurality of region of interest with a second media element.

3. The video processing circuitry of claim 2, further comprising:
a communication interface that receives the first media element and the second media element from the video source, and
wherein the communication interface receives a third media element from a second video source.

4. The video processing circuitry of claim 3 wherein the video processing circuitry is a set top box and the video source is a television channel broadcasting source, the video processing circuitry further comprising:
a first TV channel including the first media element wherein the first media element includes the first plurality of region of interest that can be selected by the viewer using the viewer interface; and
a second TV channel including the second media element that can be selected by the viewer using the viewer interface,
wherein the processing circuit generating a combined video by combining at least one of the first plurality of region of interest with the second media element.

5. The video processing circuitry of claim 4, further comprising:
a display interface through which the processing circuit delivers the composite video to a display unit.

6. The video processing circuitry of claim 5, wherein the first TV channel and the second TV channel are identified by the viewer via the viewer interface from a plurality of TV channels provided by the television channel broadcasting source.

7. The video processing circuitry of claim 6, further comprising:
the processing circuitry generating the combined output by overlaying a frame that displays at least one of the first plurality of region of interest on a second frame that displays at least a portion of the second media element, the second frame configured to occupy all of the display space on the display unit.

8. The video processing circuitry of claim 2, further comprising:
the second media element including a second plurality of region of interest;
the viewer selection including at least one of the first plurality of region of interest that is selected by the viewer and at least one of the second plurality of region of interest that is selected by the viewer; and
wherein the processing circuit generates a combined video by combining the at least one of the first plurality of region of interest with the at least one of the second plurality of region of interest.

9. The video processing circuitry of claim 8, further comprising:
a second video source that is local at the first premises that provides a third media element including a third plurality of region of interest;
wherein the viewer selection includes at least one of the first plurality of region of interest that is selected by the viewer and at least one of the third plurality of region of interest that is selected by the viewer; and
wherein the processing circuit generates a combined video by combining the at least one of the first plurality of region of interest with the at least one of the third plurality of region of interest.

10. The video processing circuitry according to claim 9, further comprising a memory that is communicatively coupled to the processing circuit, the memory capable of storing the viewer selection received via the viewer interface.

11. The video processing circuitry according to claim 10, wherein the viewer selection received via the viewer interface including a display shape and a display dimension of the portion of the first media element that needs to be displayed.

12. The video processing circuitry according to claim 10, wherein the viewer selection received via the viewer interface including the display shape and the display dimension of the at least one of the first plurality of region of interest that needs to be displayed.

13. The video processing circuitry according to claim 10, wherein the viewer selection received via the viewer interface comprising the display characteristics for the combined output.

14. The video processing circuitry according to claim 1, further comprising an accounting system coupled to the processing circuitry, wherein the accounting system maintains a usage record for the viewer.

15. A set top box circuitry that receives a channel menu and a plurality of television channels from a television channel broadcasting source, the set top box circuitry comprising:
a processing circuitry;
wherein the set top box circuitry facilitates viewing and browsing of the channel menu by a viewer on a display unit communicatively coupled to the set top box circuitry;
wherein the set top box circuitry facilitating the selection and creation of the viewer selection by the viewer based on the channel menu, wherein the viewer selection includes one or more television channels of the plurality of television channels provided by the television channel broadcasting source, and
wherein each of the television channels includes at least one media element;
a plurality of channel selectors configured to retrieve the one or more television channels based on the viewer selection; and
wherein the processing circuitry creates a combined video based on at least a portion of each of the one or more television channels that are retrieved based on the viewer selection.

16. The set top box circuitry according to claim 15, wherein the channel menu includes identification of the plurality of television channels provided by the television channel broadcasting source to the set top box circuitry, and wherein at least one of the plurality of television channels provide a media element with an associated metadata that can be viewed by a viewer on the display unit.

17. The set top box circuitry according to claim 16, further comprising:
a communication interface capable of interacting with a remote control communicatively coupled to the set top box circuitry;
wherein the processing circuitry facilitates the selection by the viewer, via the remote control, of the one or more television channels.

18. The set top box circuitry according to claim 17, further comprising:
wherein the media element includes a plurality of region of interest; and
wherein the metadata comprising details of the plurality of region of interest;
wherein the processing circuitry facilitates the viewing of the metadata and the selection of at least one of the plurality of region of interest by the viewer via the remote control; and
wherein the processing circuitry creates a combined video based on the at least one of the plurality of region of interest and the one or more television channels that are retrieved based on the viewer selection.

19. The set top box circuitry according to claim 18, further comprising:
an accounting support system that is communicatively coupled to the processing circuitry, wherein the accounting support system maintains a usage record for the viewer.

20. The set top box circuitry according to claim 18, further comprising:
an accounting support system that is communicatively coupled to the processing circuitry, wherein the accounting support system communicates a charging detail record to a charging system at a remote location.

21. A method performed by a set top box circuitry located at a first premises of generating a composite video employing one or more of the plurality of media elements received from a video source located at a second premises, the method comprising:
receiving the plurality of media elements, each of the plurality of media element including a plurality of regions of interest and being associated with a metadata that includes information on the plurality of regions of interest;
selecting the one or more of the plurality of media elements;
displaying a list of regions of interest from the one or more of the plurality of media elements selected for review and selection by the viewer;
collecting a selected regions of interest select by the viewer; and
combining the selected regions of interest with at least one of the one or more of the plurality of media elements received from a video source to generate the composite video.

22. The method performed by a set top box circuitry according to claim 21, wherein the selecting step includes:
presenting a menu of media elements and their associated plurality of regions of interest; and
accepting a viewer's selection of media elements from the menu of media elements presented.
